(19) United States
(12) Patent Application Publication
(10) Pub. No.: US 2025/0353720 A1
(43) Pub. Date: Nov. 20, 2025

(54) LIQUID PUMPING DEVICE AND LIQUID PUMPING AND LID OPENING APPARATUS

(71) Applicant: ASIA IC MIC-PROCESS, INC., Taipei City (TW)

(72) Inventor: YAN-LAN CHIOU, Taipei City (TW)

(73) Assignee: ASIA IC MIC-PROCESS, INC., Taipei City (TW)

(21) Appl. No.: 18/890,796

(22) Filed: Sep. 20, 2024

(30) Foreign Application Priority Data
May 17, 2024 (TW) 113205101

(51) Int. Cl. B67B 7/18; F04B 19/02

(52) U.S. Cl. CPC B67B 7/182; F04B 19/022

(57) ABSTRACT

A liquid pumping device includes a liquid pumping tube module, an axial movement module, a rotation module and a translation module. The liquid pumping tube module includes a tube and an adapter. The tube has a first end and a second end in an axial direction. The adapter is disposed at the second end. The axial movement module is connected to the tube, and drives the liquid pumping tube module to move in the axial direction. The rotation module is connected to the liquid pumping tube module, and drives the liquid pumping tube module to rotate relative to a rotation axis of the rotation module. The translation module is connected to the liquid pumping tube module, and drives the liquid pumping tube module to move on a plane perpendicular to a plane of rotation of the rotation module.

### CROSS-REFERENCE TO RELATED APPLICATION

This non-provisional application claims priority under 35 U.S.C. § 119(a) on Patent Application No(s). 113205101 filed in Taiwan, R.O.C. on May 17, 2024, the entire contents of which are hereby incorporated by reference.

### BACKGROUND OF THE INVENTION

### 1. Field of the Invention

The present disclosure relates to a liquid pumping device and a liquid pumping and lid opening apparatus, and in particular to a liquid pumping device and a liquid pumping and lid opening apparatus capable of reducing an overall space occupied by the liquid pumping device.

### 2. Description of the Related Art

In the industrial fields such as semiconductors and optoelectronics, chemical liquids and grinding liquids used in manufacturing processes are stored in chemical liquid tanks, which are stored in chemical liquid pumping cabinets.

In a conventional liquid pumping approach, a liquid pumping tube is inserted into a chemical liquid tank in a chemical liquid pumping cabinet manually by operating staff so as to pump the liquid in the tube, in a way that a fully automated operation of the chemical liquid pumping cabinet cannot be achieved. Moreover, the manual operation can cause issues such as contamination of the chemical liquid or health hazards of the operating staff.

As an alternative, to operate the liquid pumping tube in a fully automated manner, one obvious problem is that the liquid pumping tube and a machine operating the liquid pumping tube are inserted into the chemical liquid tank in a straight-down and straight-up approach, and this in practice occupies too much space and is thus infeasible for current chemical liquid pumping cabinets.

### BRIEF SUMMARY OF THE INVENTION

Therefore, to solve the various issues of a conventional liquid pumping device, the present disclosure provides a liquid pumping device and a liquid pumping and lid opening apparatus capable of reducing an overall space occupied by the liquid pumping device

To achieve the above and other objectives, the present disclosure provides a liquid pumping device, including: a liquid pumping tube module, including a tube and an adapter, the tube having a first end and a second end in an axial direction, the adapter disposed at the second end; an axial movement module, connected to the tube, the axial movement module driving the liquid pumping tube module to move in the axial direction; a rotation module, connected to the liquid pumping tube module, the rotation module driving the liquid pumping tube module to rotate relative to a rotation axis of the rotation module; and a translation module, connected to the liquid pumping tube module, the translation module driving the liquid pumping tube module to move on a plane perpendicular to a plane of rotation of the rotation module.

In one embodiment of the present disclosure, the axial movement module includes a first motor, a first gear and a rack. The first gear is connected to the first motor and engages with the rack, and the rack is connected to the second end.

In one embodiment of the present disclosure, the rotation module includes a second motor. The second motor is connected to the liquid pumping tube module via the axial movement module.

In one embodiment of the present disclosure, the translation module is connected to the liquid pumping tube module via the rotation module and the axial movement module.

In one embodiment of the present disclosure, the translation module is a linear movement module.

To achieve the above and other objectives, the present disclosure further provides a liquid pumping and lid opening apparatus, including: the liquid pumping device above; a lid opening device, including a lid opening module and a movement module, the lid opening module including a rotation motor, a lid opening unit and a plurality of claws, the rotation motor outputting a rotational power to the lid opening unit, the plurality of claws surrounding the lid opening unit, the movement module connected to the lid opening module and driving the lid opening module to move; and a control device, signally connected to the liquid pumping device and the lid opening device, the control device controlling movements of the liquid pumping tube module and the lid opening module.

In one embodiment of the present disclosure, one end of each of the plurality of claws is provided with a buffer member.

In one embodiment of the present disclosure, the movement module includes three linear movement modules connected to the lid opening module, and respective linear movement directions of the three linear movement modules are perpendicular to one another.

In one embodiment of the present disclosure, the liquid pumping and lid opening apparatus further includes a plurality of sensing devices signally connected to the control device. The plurality of sensing devices respectively sense movement states of the liquid pumping tube module and the lid opening module.

Accordingly, the liquid pumping device and the liquid pumping and lid opening apparatus of the present disclosure are capable of extending a tube into a tank in an inclined manner through a window of a chemical liquid pumping cabinet and hence reducing an overall space occupied by the liquid pumping device. Compared with costly mechanical arms having a large volume, the liquid pumping device and the liquid pumping and lid opening apparatus of the present disclosure are more advantageous in terms of offering more flexible installation sizes in the environment and more competitive mechanism costs. Thus, the liquid pumping device and the liquid pumping and lid opening apparatus of the present disclosure are beneficial in use of a limited space of a chemical liquid pumping cabinet and can effectively adapt to current chemical liquid pumping cabinets.

### BRIEF DESCRIPTION OF THE DRAWINGS

FIG. 1 is a perspective schematic diagram of a liquid pumping device according to an embodiment of the present disclosure.

FIG. 2 is a schematic diagram of a movement of a liquid pumping device according to an embodiment of the present disclosure.

FIG. 3 is a simplified diagram of an operation of a liquid pumping device according to an embodiment of the present disclosure.

FIG. 4 is a perspective schematic diagram of a liquid pumping and lid opening apparatus according to an embodiment of the present disclosure.

FIG. 5 is a perspective schematic diagram of a lid opening device according to an embodiment of the present disclosure.

FIG. 6 is a perspective schematic diagram of a lid opening module according to an embodiment of the present disclosure.

FIG. 7 is a block diagram of a liquid pumping and lid opening apparatus according to an embodiment of the present disclosure.

### DETAILED DESCRIPTION OF THE INVENTION

To fully understand the present disclosure, the present disclosure is described in detail by way of the specific embodiments with the accompanying drawings below. A person skilled in the art would be able to understand the objectives, features and effects of the present disclosure from the disclosure of the present application. It should be noted that, the present disclosure may be implemented or applied by other specific embodiments, and changes or modifications may also be made on the basis of different perspectives and applications to various details in the description without departing from the spirit of the present disclosure. Technical contents associated with the present disclosure are described in detail below, and it should be noted that the disclosure is not to be construed as limitations to the scope of claims of the present disclosure. Associated details are provided in the description below.

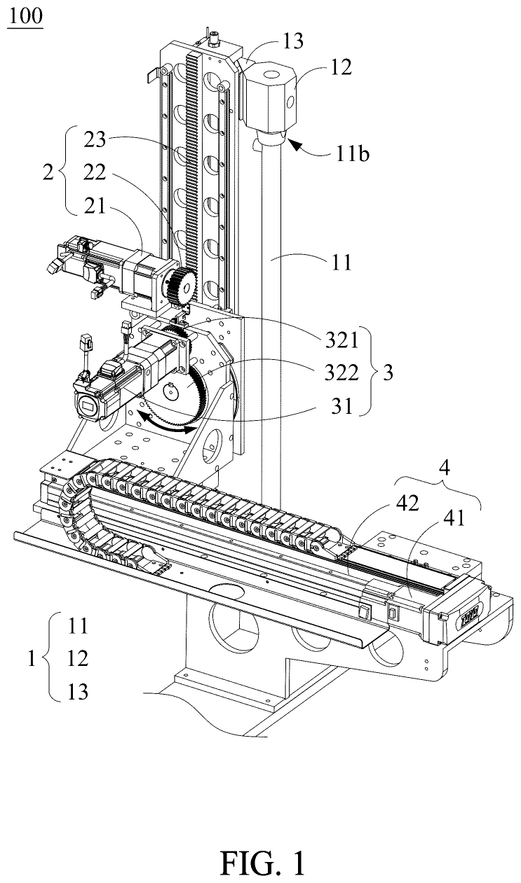

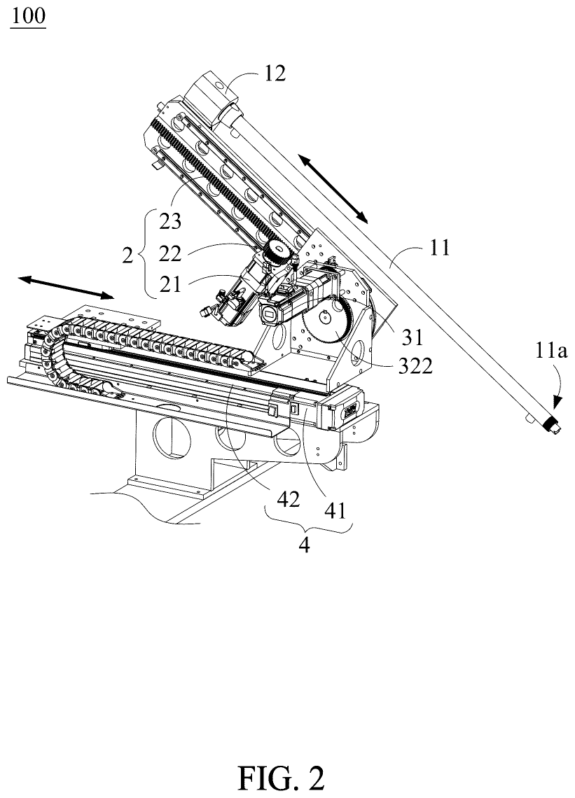

As shown in FIG. 1 and FIG. 2, a liquid pumping device 100 according to an embodiment of the present disclosure includes a liquid pumping tube module 1, an axial movement module 2, a rotation module 3 and a translation module 4.

The liquid pumping tube module 1 includes a tube 11 and an adapter 12. The tube 11 has a first end 11a and a second end 11b in an axial direction. The first end 11a extends to a tank T, and the second end 11b is an end (a distal end) opposite to the first end 11a. The tube 11 is, for example, a jet stirring pipe disclosed by Taiwan Patent Publication No. I812886, and has liquid pumping and liquid spraying functions to achieve a stirring effect. The tube 11 can also be an ordinary tube having a common communicating function, and is not specifically limited by the present disclosure. The adapter 12 is disposed at the second end 11b of the tube 11, and is operable to connect to a pumping power apparatus such as an external pump or other apparatuses.

The axial movement module 2 is connected to the tube 11, and functions to drive the liquid pumping tube module 1 to move in the axial direction. More specifically, in this embodiment, the axial movement module 2 includes a first motor 21, a first gear 22 and a rack 23. The first gear 22 is connected to the first motor 21 and engages with the rack 23, and the rack 23 is connected to the adapter 12 and the second end 11b via a connection block 13. When the first motor 21 rotates, a rotational power is output to the first gear 22 and enables the rack 23 to move relative to the first gear 22, thereby driving the liquid pumping tube module 1 to move in the axial direction. The axial movement module 2 is operable to adjust a depth by which the tube 11 extends toward the tank T. However, the present disclosure is not limited to the example above. In other embodiments, the axial movement module 2 can drive the liquid pumping tube module 1 to move linearly by other means, for example, by using a cylinder or a combination of a motor and a screw rod. Moreover, the connection block 13 is optional, and the rack 23 can be directly connected to the tube 11 or the adapter 12 so as to drive the tube 11.

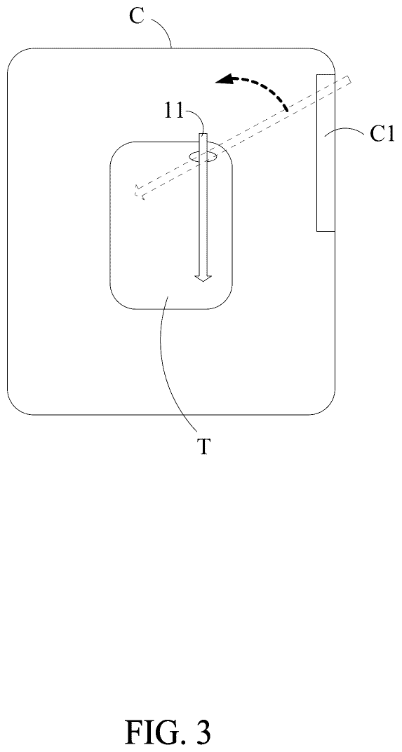

The rotation module 3 is connected to the liquid pumping tube module 1, and drives the liquid pumping tube module 1 to rotate relative to a rotation axis of the rotation module 3. In this embodiment, the rotation module 3 includes a second motor 31. The second motor 31 is connected to the liquid pumping tube module 1 via the axial movement module 2; that is to say, the second motor 31 simultaneously rotates to drive the axial movement module 2 and the liquid pumping tube module 1 connected to the axial movement module 2. However, the present disclosure is not limited to the example above. In other embodiments, the rotation module 3 can be directly connected to the liquid pumping tube module 1 instead of being connected to the liquid pumping tube module 1 via the axial movement module 2, or the axial movement module 2 is indirectly connected to the liquid pumping tube module 1 via the rotation module 3. In this embodiment, the rotation module 3 further includes a gear set. The gear set includes a small gear 321 and a large gear 322. The small gear 321 sleeves the rotation axis of the second motor 31 and engages with the large gear 322, and the small gear 321 and the large gear 322 are operable to alleviate an output speed of the second motor 31. A center of axis of the large gear 322 is connected to the rack 23 of the axial movement module 2. Thus, when the second motor 31 outputs a rotational power, the rotational power is output from the rotation of the second motor 31 sequentially to the small gear 321 and the large gear 322, and the large gear 322 drives the rack 23 and the liquid pumping tube module 1 connected to the rack 23 to rotate. Since the axial direction of the tube 11 is located on the plane of rotation of the rotation module 3 (as shown in FIG. 2 and FIG. 3), a depth by which the tank 11 extends toward the tank T can be changed within a limited space without involving an overly large vertical space. However, the present disclosure is not limited to the example above. In other embodiments, the second motor 31 can directly drive the liquid pumping tube module 1 without going through the gear set, or can have a gear set in other forms so as to achieve the required effect.

The translation module 4 is connected to the liquid pumping tube module 1, and drives the liquid pumping tube module 1 to move on a plane which is perpendicular to the plane of rotation of the rotation module 3. That is to say, the translation module 4 is operable to increase the mobility of the liquid pumping tube module 1 in other dimensions. In this embodiment, the translation module 4 is connected to the liquid pumping tube module 1 via the rotation module 3 and the axial movement module 2; that is to say, the translation module 4 simultaneously drives the rotation module 3, the axial movement module 2 and the liquid pumping tube module 1. However, the present disclosure is not limited to the example above. In other embodiments, the translation module 4 can be directly connected to the liquid pumping tube module 1 without going through the rotation module 3 or the axial movement module 2. In this embodiment, the translation module 4 is a linear movement module, includes a third motor 41 and a screw rod (not shown), and is operable to move linearly along a horizontal guide rail 42. However, the present disclosure is not limited to the example above. In other embodiments, the third motor 41 can coordinate with other types of mechanisms to change the rotational power into a linear power. Alternatively, the translation module 4 is configured to drive the liquid pumping tube module 1 to move on a horizontal plane by a power mechanism such as an air cylinder or a hydraulic cylinder. In other embodiments, the translation module 4 can include more power mechanisms, so that the liquid pumping tube module 1 is further capable of moving two-dimensionally on a horizontal plane in addition to moving linearly.

As shown in FIG. 3, the liquid pumping device 100 of the present disclosure is capable of extending the tube 11 into the tank T through a window C1 of a chemical liquid pumping cabinet C and reducing an overall space occupied by the liquid pumping device 100, and thus are beneficial in use of a limited space of the chemical liquid pumping cabinet C and can effectively adapt to the current chemical liquid pumping cabinet C. Compared with costly mechanical arms having a large volume, the liquid pumping device 100 of the present disclosure is more advantageous in terms of offering more flexible installation sizes in the environment and more competitive mechanism costs. The liquid pumping device 100 of the present disclosure is suitable for fully automated operations; however, the present disclosure is not limited to such application. Moreover, the liquid pumping device 100 of the present disclosure is also applicable in semi-automated operations or manual operations performed by the operating staff.

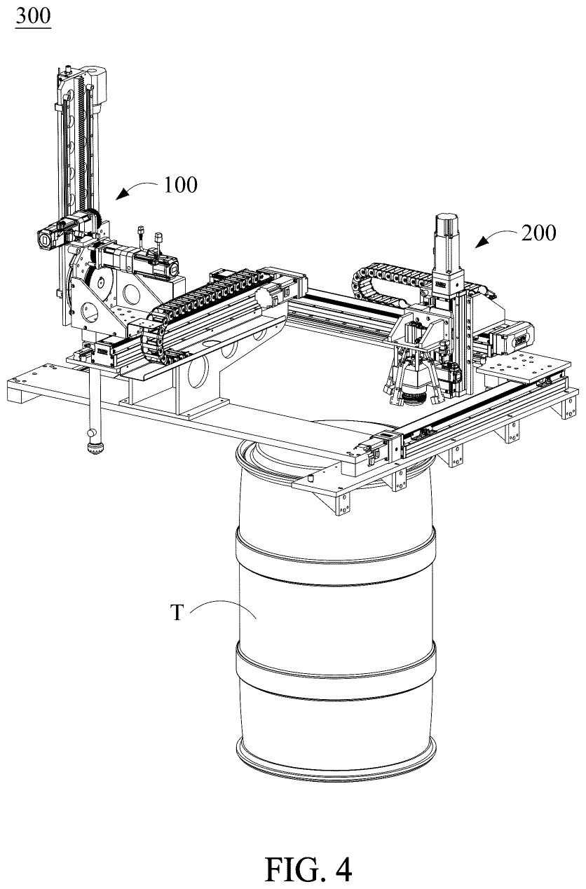

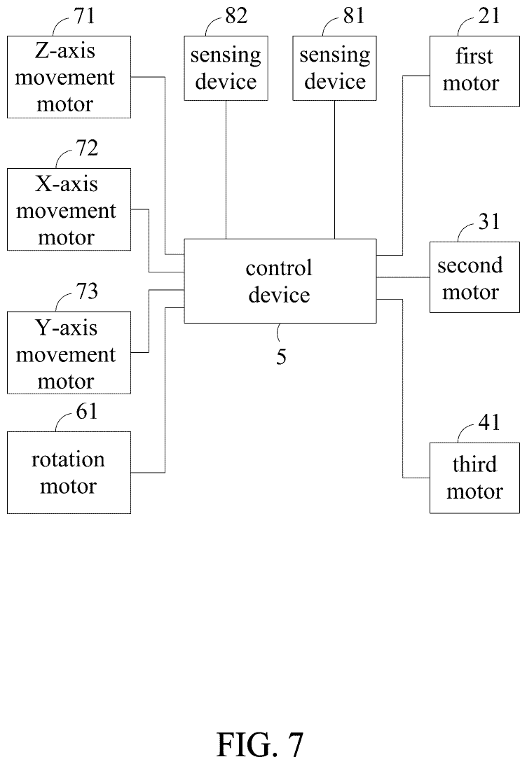

Further, as shown in FIG. 4 and FIG. 7, the present disclosure further provides a liquid pumping and lid opening apparatus 300 including the liquid pumping device 100 above, a lid opening device 200 and a control device 5.

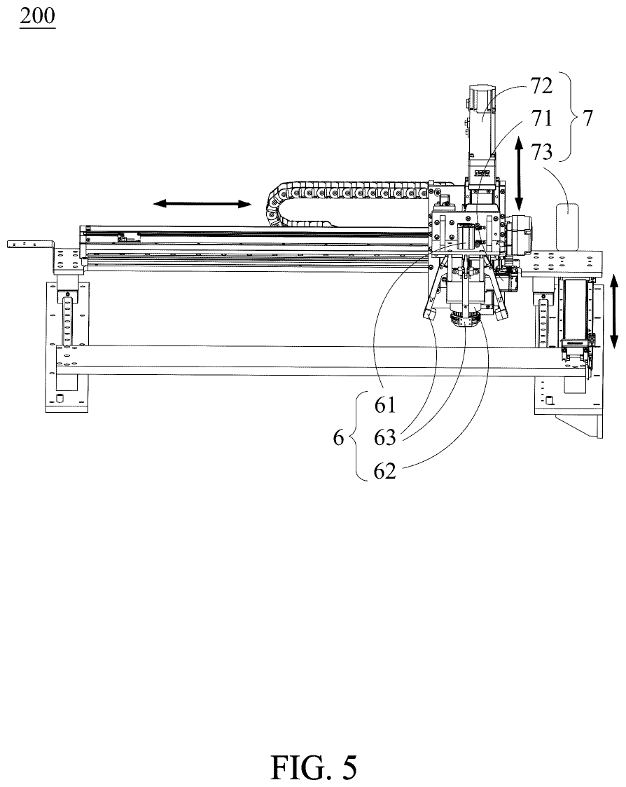

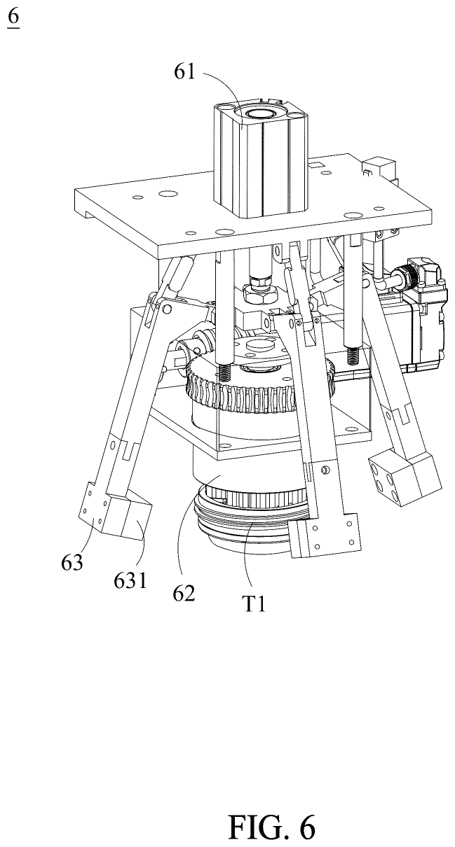

As shown in FIG. 5 and FIG. 6, the lid opening device 200 includes a lid opening module 6 and a movement module 7.

The lid opening module 6 includes a rotation motor 61, a lid opening unit 62 and a plurality of claws 63. The rotation motor 61 outputs the rotational power to the lid opening unit 62, and the plurality of claws 63 surround the lid opening unit 62 at intervals of equal angles. The lid opening unit 62 is operable to match a cover member T1 of the tank T. When the rotation motor 61 outputs the rotational power to the lid opening unit 62 via a rotation shaft thereof, the lid opening unit 62 drives the cover member T1 to rotate such that the cover member T1 detaches from the tank T. The plurality of claws 63 are operable to assist in clamping the cover member T1. In this embodiment, one end of each of the plurality of claws 63 is provided with a buffer member 631. The buffer member 631 is a member which is relatively flexible and elastically deformable, and is, for example, a rubber member. The buffer member 631 is disposed toward the lid opening unit 62, and is positioned to physically come into contact with and clamp the cover member T1.

The movement module 7 is connected to the lid opening module 6 and drives the lid opening module 6 to move, so as to have the lid opening unit 62 match the position of the cover member T1. In this embodiment, the movement module 7 includes three linear movement modules connected to the lid opening module 6 so as to move the lid opening module 6 three-dimensionally. Preferably, respective linear movement directions of the three linear movement modules are perpendicular to one another. The three linear movement modules in total include a Z-axis movement motor 71, an X-axis movement motor 72 and a Y-axis movement motor 73, as well as respective related mechanisms, so as to convert the rotational power of each of the motors into a linear power to thereby move the lid opening module 6 in the X axis, Y axis and Z axis. However, the present disclosure is not limited to the example above. In other embodiments, the movement module 7 can have a linear movement ability in one dimension or two dimensions.

As shown in FIG. 7, the control device 5 is signally connected to the first motor 21, the second motor 31 and the third motor 41 of the liquid pumping device 100 and the Z-axis movement motor 71, the X-axis movement motor 72 and the Y-axis movement motor 73 of the lid opening device 200. The control device 5 controls movement distances of the liquid pumping tube module 1 and the lid opening module 6 by controlling the motors above. The control device 5 is, for example, a control circuit or a control chip having a logic determination ability. The control device 5 can be further signally connected to the rotation motor 61 so as to control a lid opening process of the lid opening module 6.

Further, in this embodiment, the liquid pumping and lid opening apparatus 300 further includes a plurality of sensing devices 81 and 82 which are signally connected to the control device 5. The sensing device 81 is operable to sense a movement state of the liquid pumping tube module 1, and the sensing device 82 is operable to sense a movement state of the lid opening module 6. The sensing devices 81 and 82 are, for example, optical sensors, mechanism-triggered sensors or electromagnetic sensors detecting positions of components. However, the present disclosure is not limited to the examples above. The sensing devices 81 and 82 can individually include more sensors, and are installed in the chemical liquid pumping cabinet C to learn real-time states of the detected components. The control device 5 adjusts or fine-tunes the movement distances of the liquid pumping tube module 1 and the lid opening module 6 according to detection signals of the sensing devices 81 and 82.

For example, the control device 5 can determine according to the detection signal of the sensing device 82 whether the lid opening module 6 has moved to the position over the cover member T1, and controls the X-axis movement motor 72 and the Y-axis movement motor 73 to move horizontally if the determination is negative. Next, the Z-axis movement motor 71 is controlled to descend the lid opening module 6 such that the lid opening unit 62 matches the cover member T1, and then the control device 5 controls the rotation motor 61 to rotate so as to perform lid opening. After the lid opening is complete, the control device 5 controls the first motor 21, the second motor 31 and the third motor 41 to move sequentially and rotate the liquid pumping tube module 1 according to the detection signal of the sensing device 81, such that the tube 11 extends deep into the tank T.

In conclusion, the liquid pumping device 100 and the lid opening device 200 of the present disclosure are capable of reducing an overall space occupied by the liquid pumping device, forming the automated liquid pumping and lid opening apparatus 300 having a more compact and efficient operating space. Moreover, the automatically controlled liquid pumping and lid opening functions of the liquid pumping device 100 and the lid opening device 200 of the present disclosure can be modularized so as to readily modify and install the liquid pumping device 100 and the lid opening device 200 in an existing manually operated liquid pumping apparatus, thereby implementing unmanned automation from manual operations.

The present disclosure is described by way of the preferred embodiments above. A person skilled in the art should understand that, these embodiments are merely for illustrating the present invention and are not to be construed as limitations to the scope of the present disclosure. It should be noted that all equivalent changes, replacements and substitutions made to the embodiments are encompassed within the scope of the present disclosure. Therefore, the legal protection for the present disclosure should be defined by the appended claims.

What is claimed is:

1. A liquid pumping device, comprising:
a liquid pumping tube module, comprising a tube and an adapter, the tube having a first end and a second end in an axial direction, the adapter disposed at the second end;
an axial movement module, connected to the tube, the axial movement module driving the liquid pumping tube module to move in the axial direction;
a rotation module, connected to the liquid pumping tube module, the rotation module driving the liquid pumping tube module to rotate relative to a rotation axis of the rotation module; and
a translation module, connected to the liquid pumping tube module, the translation module driving the liquid pumping tube module to move on a plane which is perpendicular to a plane of rotation of the rotation module.

2. The liquid pumping device according to claim 1, wherein the axial movement module comprises a first motor, a first gear and a rack, the first gear is connected to the first motor and engages with the rack, and the rack is connected to the second end.

3. The liquid pumping device according to claim 1, wherein the rotation module comprises a second motor, which is connected to the liquid pumping tube module via the axial movement module.

4. The liquid pumping device according to claim 1, wherein the translation module is connected to the liquid pumping tube module via the rotation module and the axial movement module.

5. The liquid pumping device according to claim 1, wherein the translation module is a linear movement module.

6. A liquid pumping and lid opening apparatus, comprising:
the liquid pumping device according to claim 1;
a lid opening device, comprising a lid opening module and a movement module, the lid opening module comprising a rotation motor, a lid opening unit and a plurality of claws, the rotation motor outputting a rotational power to the lid opening unit, the plurality of claws surrounding the lid opening unit, the movement module connected to the lid opening module and driving the lid opening module to move; and
a control device, signally connected to the liquid pumping device and the lid opening device, the control device controlling movements of the liquid pumping tube module and the lid opening module.

7. The liquid pumping and lid opening apparatus according to claim 6, wherein one end of each of the plurality of claws is provided with a buffer member.

8. The liquid pumping and lid opening apparatus according to claim 6, wherein the movement module comprises three linear movement modules connected to the lid opening module, and respective linear movement directions of the three linear movement modules are perpendicular to one another.

9. The liquid pumping and lid opening apparatus according to claim 6, further comprising a plurality of sensing devices signally connected to the control device, the plurality of sensing devices respectively sensing movement states of the liquid pumping tube module and the lid opening module.
